(19) United States
(12) Patent Application Publication
(10) Pub. No.: US 2013/0247753 A1
(43) Pub. Date: Sep. 26, 2013

(54) Fluid Cylinder Assembly Having Automatic Stroke Shutoff

(71) Applicant: ACTUANT CORPORATION, Milwaukee, WI (US)

(72) Inventor: Frantz D. Stanford, Monona, WI (US)

(73) Assignee: Actuant Corporation, Milwaukee, WI (US)

(21) Appl. No.: 13/847,249

(22) Filed: Mar. 19, 2013

Related U.S. Application Data
(60) Provisional application No. 61/614,301, filed on Mar. 22, 2012.

(51) Int. Cl. F16J 10/00

(52) U.S. Cl. CPC F16J 10/00
USPC 92/169.1

(57) ABSTRACT

The fluid cylinder assembly concept includes a valve that automatically diverts fluid between pressure chambers when a plunger nears its end of stroke to inhibit the plunger from overtravel.

### CROSS REFERENCE TO RELATED APPLICATIONS

This application claims priority to U.S. Provisional Application No. 61/614,301 filed Mar. 22, 2012, which is incorporated herein by reference.

### STATEMENT REGARDING FEDERALLY SPONSORED RESEARCH

Not applicable.

### BACKGROUND OF THE INVENTION

The present invention relates to fluid cylinder assemblies, and more particularly to a fluid cylinder assembly incorporating automatic stroke shutoff.

Fluid cylinder assemblies are used in various applications to, for instance, raise and lower loads, extend and retract members, and provide general motion control. One problem common to most fluid cylinder assemblies is known as “overtravel.” Overtravel occurs when fluid pressure urges a plunger beyond its designed stroke range, such as when a control valve is maintained in an open position after the plunger is fully extended. Pressure spikes occur during overtravel that can induce additional stress causing damage to the fluid cylinder and degrade other components coupled to the system (e.g., valves, hoses, couplings, etc.).

Several attempts have been made to minimize the detrimental effects of overtravel. One approach involves strengthening portions of the fluid cylinder assembly that are impacted by overtravel. For instance, some cylinders include a “stopring” that is designed to withstand the force of a fully extended plunger that remains under fluid pressure. A stepped plunger is also typically required to engage the stopring. These stoprings and stepped plungers, however, increase the cost and complexity of the overall fluid cylinder assembly, while not reducing the undesirable stresses. Another approach involves a weep hole positioned in a pressure chamber. When a plunger nears the end of its stroke, a seal passes over the weep hole and pressurized fluid within the pressure chamber is vented through the weep hole, which reduces the forces and stresses of overtravel. However, in addition to the weep hole undesirably leaking fluid, this repeated movement of the seal across the weep hole damages the plunger seal and ultimately degrades operation of the overall fluid cylinder assembly.

In light of at least the above, a need exists for a fluid cylinder assembly incorporating an improved automatic stroke shutoff.

### SUMMARY OF THE INVENTION

The fluid cylinder assembly concept includes a valve that automatically diverts fluid between pressure chambers when a plunger nears its end of stroke, thereby inhibiting the plunger from undesirable overtravel.

In one aspect, a fluid cylinder assembly comprises a cylinder base and a plunger bore that is defined by the cylinder base. A plunger is slidably seated within the plunger bore between a retracted position and an extended position, and a chamber bore is defined by the plunger. A chamber member has a first end coupled to the cylinder base and a second end slidably engaged with the chamber bore. An advance chamber is bounded by the plunger bore and the plunger, and a retract chamber is bounded by the chamber bore and the chamber member. A shunt passageway extends between the advance chamber and the retract chamber. A valve is seated in the shunt passageway and is moveable between a closed position at which fluid communication between the advance chamber and the retract chamber is inhibited, and an opened position at which fluid communication between the advance chamber and the retract chamber is established. The valve is positioned so that when the plunger is near the extended position the valve is in the opened position.

In another aspect, a fluid cylinder assembly comprises a cylinder base and a plunger bore that is defined by the cylinder base. A plunger is slidably seated within the plunger bore between a retracted position and an extended position, and a chamber bore is defined by the plunger. A chamber member has a first end coupled to the cylinder base and a second end slidably engaged with the chamber bore. A divider is coupled to the plunger and is slidably engaged about the chamber member. An advance chamber is bounded by the plunger bore, the plunger, the chamber member, and the divider. A retract chamber is bounded by the chamber bore, the chamber member, and the divider. A shunt passageway is formed through the divider to provide fluid communication between the advance chamber and the retract chamber. A valve is seated in the shunt passageway and coupled to the divider. The valve is moveable between a closed position at which fluid communication between the advance chamber and the retract chamber is inhibited, and an opened position at which fluid communication between the advance chamber and the retract chamber is established. The valve is positioned so that the valve engages the chamber member when the plunger is near the extended position to actuate the valve from the closed position to the opened position to establish fluid communication between the advance chamber and the retract chamber.

These and still other aspects will be apparent from the description that follows. In the detailed description, preferred example embodiments will be described with reference to the accompanying drawings. These embodiments do not represent the full scope of the concept; rather the concept may be employed in other embodiments. Reference should therefore be made to the claims herein for interpreting the breadth of the invention.

### BRIEF DESCRIPTION OF THE DRAWINGS

FIG. 1 is an isometric view of an example fluid cylinder assembly in a retracted state.

FIG. 2 is a cross section along line 2-2 shown in FIG. 1 of the example fluid cylinder assembly in a retracted state.

FIG. 3 is a cross section similar to FIG. 2 showing the example fluid cylinder assembly in an extended state.

FIG. 4 is an isometric view of the example fluid cylinder assembly in the extended state.

FIG. 5 is a cross section along line 5-5 shown in FIG. 4 of the example fluid cylinder assembly in the extended state.

FIG. 6 is a partial section view of the area circumscribed by arc 6-6 shown in FIG. 5 of an example shunt valve assembly in a closed position.

FIG. 7 is a partial section view similar to FIG. 6 showing the example shunt valve assembly in an opened position.

FIG. 8 is a partial exploded top isometric view showing the example shunt valve assembly.

FIG. 9 is a partial exploded bottom isometric view of the example shunt valve assembly.

FIG. 10 is a section view of an alternative example fluid cylinder assembly in an extended state.

FIG. 11 is a cross section along line 11-11 shown in FIG. 10 of the alternative example fluid cylinder assembly in the extended state.

### DETAILED DESCRIPTION OF THE PREFERRED EXAMPLE EMBODIMENT

The fluid cylinder assembly concept that inhibits overtravel is described in the context of a hydraulic cylinder assembly (“cylinder assembly 10”) typically used as a lifting cylinder. However, as one skilled in the art will appreciate when given the benefit of this disclosure, the broader fluid cylinder assembly concept can be adapted to other applications and types of fluid cylinder assemblies, such as the various fluid cylinder assemblies manufactured by Enerpac of Menomonee Falls, Wis. The term fluid(s) includes pneumatic fluids, hydraulic fluids, and other types/forms of fluid that can be used in a cylinder assembly. Furthermore, throughout the description, terms such as front, back, side, top, bottom, up, down, upper, lower, inner, outer, above, below, and the like are used to describe the relative arrangement and/or operation of various components of the example embodiment; however, none of these relative terms are to be construed as limiting the construction or alternative arrangements that are within the scope of the claims.

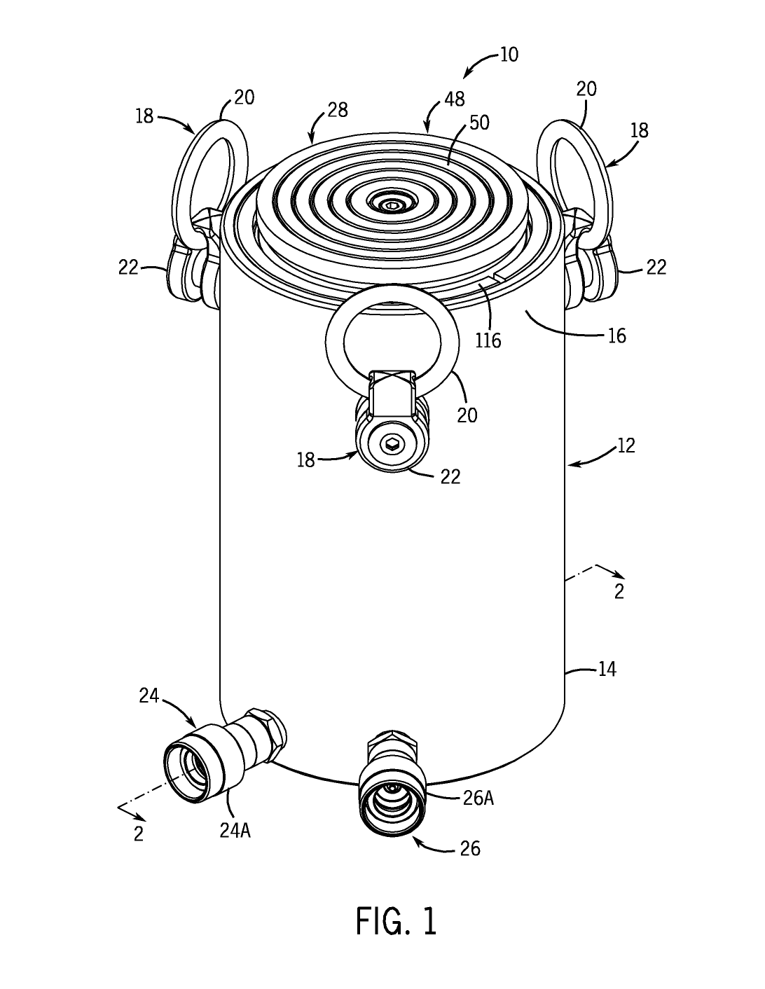

FIG. 1 is an isometric view of the example cylinder assembly 10 in a retracted state. The cylinder assembly 10 includes a cylinder base 12 extending from a lower end 14 to an upper end 16. A series of shackle assemblies 18, which are used to manipulate the location of the cylinder assembly 10, are mounted near the upper end 16 of the cylinder base 12. Each shackle assembly 18 includes a ring 20 captured to a U-shaped bracket 22 that is in turn secured to the cylinder base 12. The cylinder base 12 can be manufactured from AISI 4140 steel or any other material that meets the particular application requirements.

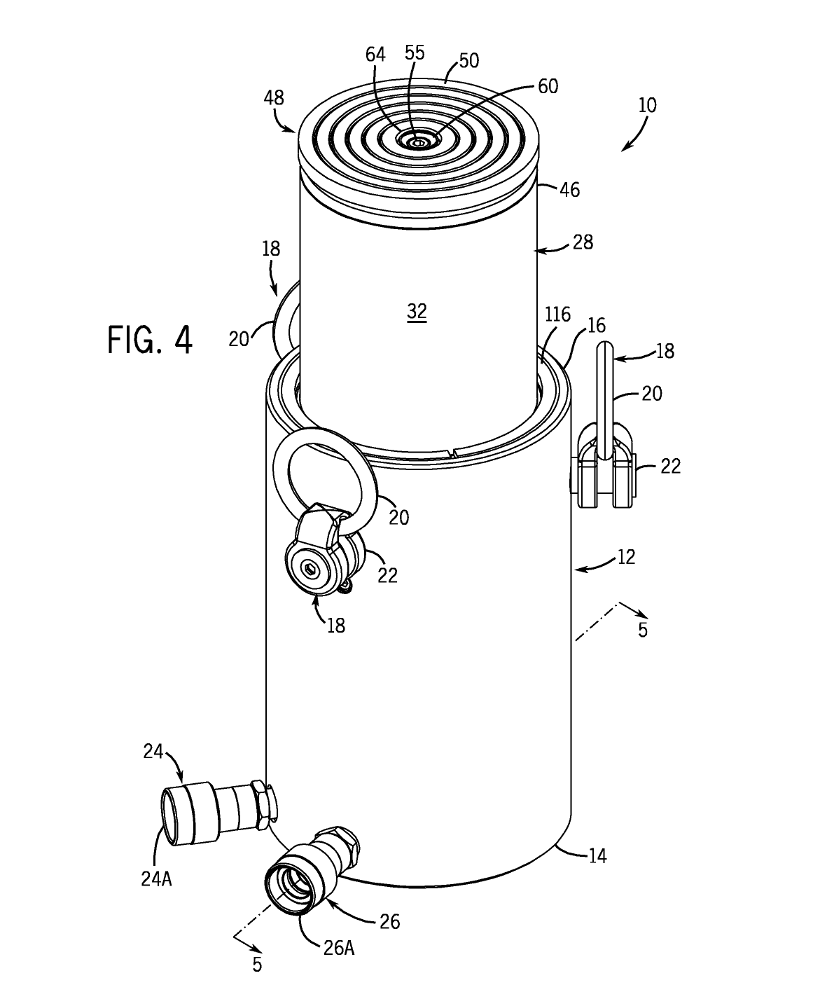

The example cylinder assembly 10 is a double-acting configuration, meaning that the cylinder assembly 10 can be urged to and between both the retracted state (shown, for instance, in FIG. 1) and an extended state (shown, for instance, in FIG. 4). The double-acting configuration incorporates an extend port 24 and a retract port 26, both of which are formed near the lower end 14 of the cylinder base 12. The extend port 24 and the retract port 26 are in fluid communication with a fluid source (e.g., a hydraulic pump and control valves) that selectively supplies pressurized fluid (e.g., hydraulic fluid) to one of the extend port 24 and the retract port 26 to ultimately extend and retract the cylinder assembly 10.

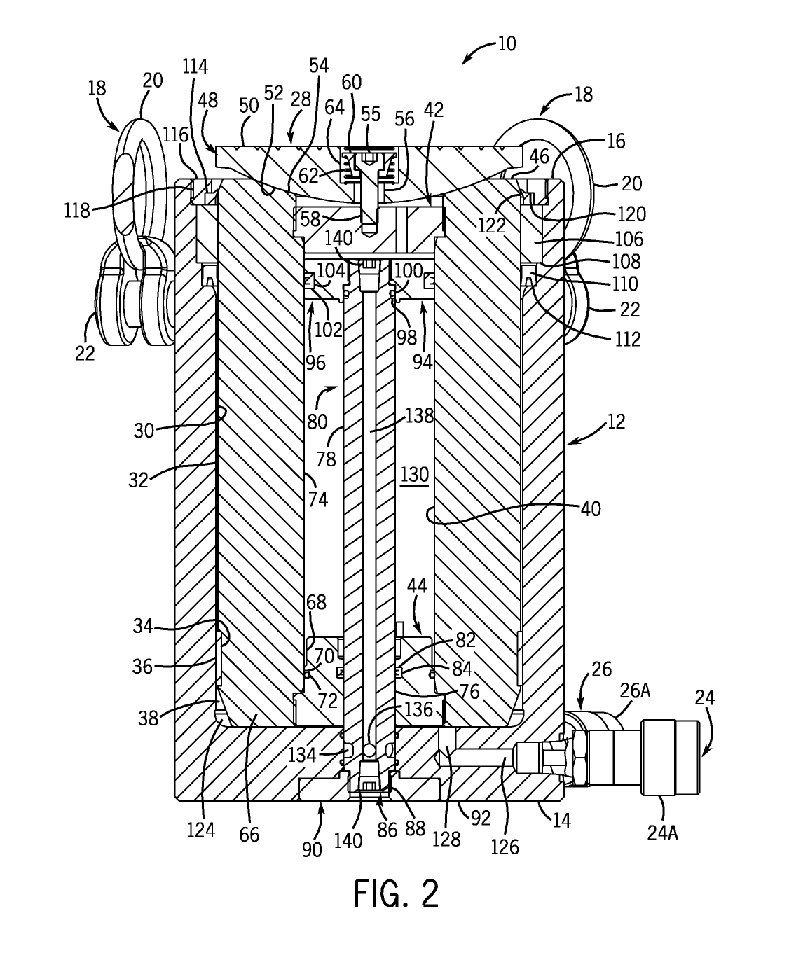

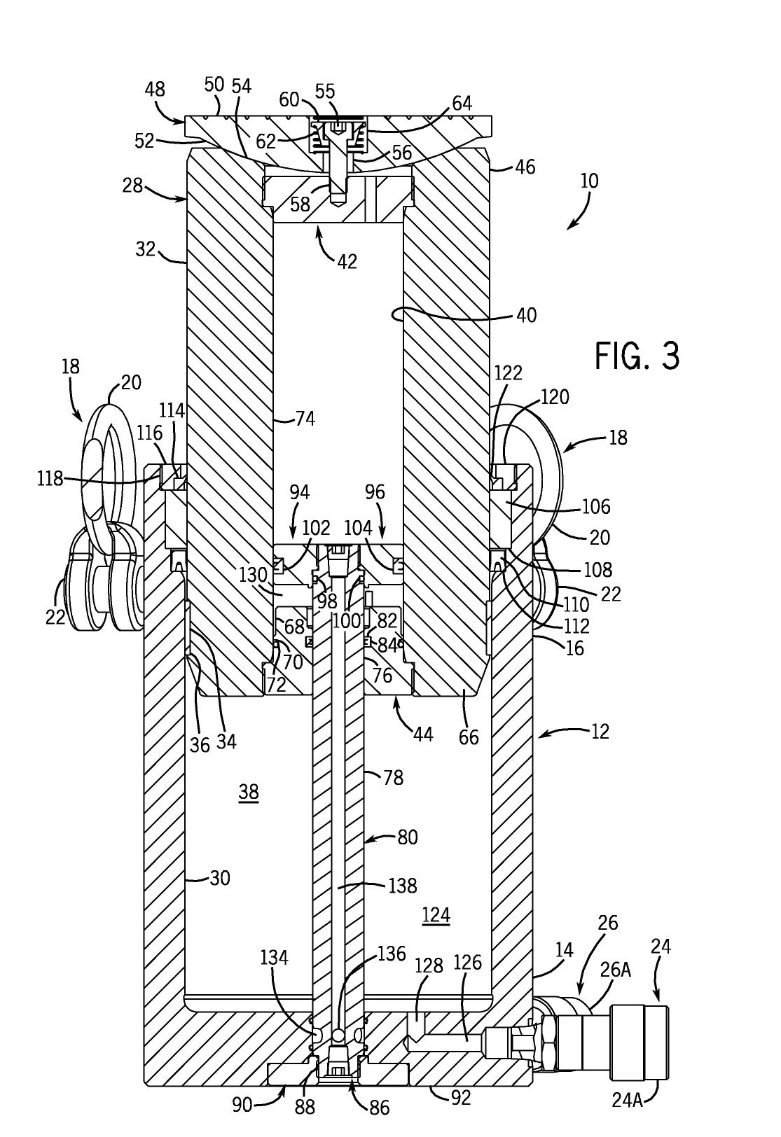

With additional reference to FIG. 2, the cylinder assembly 10 includes a plunger 28 that is slidably seated within a plunger bore 30 defined by the cylinder base 12. The plunger 28 is configured to move within the plunger bore 30 (relative to the cylinder base 12) between a retracted position shown, for instance, in FIG. 2 and an extended position shown, for instance, in FIG. 3. The plunger 28 can be manufactured from AISI 1045 steel or any other material that meets the particular application requirements. An exterior surface 32 of the plunger 28 includes an annular recess 34 near a bottom end of the plunger 28 into which a bearing 36 is seated. The bearing 36 includes two half cylinders that are aligned and seated in the recess 34 to circumscribe the plunger 28; the bearing 36 can be manufactured from fabric polymer composite. The bearing 36 rides along an interior surface 38 of the plunger bore 30 as the plunger 28 extends and retracts.

In the example cylinder assembly 10, the plunger 28 defines a central chamber bore 40 between an upper end cap 42 and a lower divider 44. Specifically, the chamber bore 40 is generally cylindrical and the end cap 42 is in the form of a circular disk that is seated (e.g., press fit, threaded) near an upper end 46 of the plunger 28. The end cap 42 can be manufactured from AISI 1045 steel. The end cap 42 also provides a mount for a saddle 48, which can be made of AISI 1045 steel. The saddle 48 has a flat top surface 50 and a convex lower surface 52 that is seated in a mating concave dish 54 formed in the upper end 46 of the plunger 28. A bolt 55 extends through an opening 56 in the saddle 48 and is engaged with a threaded bore 58 formed in the end cap 42. The bolt 55 captures a flared retainer 60 and a helical spring 62 within a pocket 64 formed in the saddle 48; this configuration allows the orientation of the top surface 50 of the saddle 48 to be adjusted (e.g., skewed relative to the balance of the cylinder assembly 10).

The bottom of the chamber bore 40 is defined by the lower divider 44, which can be manufactured from C95400 aluminum bronze. The lower divider 44 is also generally disc-shaped and is similarly seated (e.g., press fit, threaded) near a lower end 66 of the plunger 28. An exterior radial surface 68 of the lower divider 44 includes an annular groove 70 into which an o-ring 72 is seated to seal with an interior surface 74 of the chamber bore 40. The lower divider 44 is fixed to the plunger 28 such that the lower divider 44 translates with the plunger 28. In other forms, the lower divider 44 can be integrally formed with the plunger 28. The lower divider 44 also defines a central opening 76 that is sized to accommodate a tube portion 78 of a chamber member 80. Specifically, the central opening 76 includes an internal, annular recess 82 into which a seal 84 having an E-shaped cross section is seated to seal with and wipe against the tube portion 78 (e.g., a generally cylindrical pipe) of the chamber member 80 as the plunger 28 extends and retracts. The chamber member 80 may be made of AISI 4040 steel or any other suitable materials. The chamber member 80 may also be integrally formed with the balance of the cylinder base 12.

In the example embodiment, a lower end 86 of the chamber member 80 is fixed to the cylinder base 12. The lower end 86 is seated (e.g., press fit, threaded) into a central opening 88 of a mounting plate 90. The disc-shaped mounting plate 90, which can be manufactured from AISI 1144 steel, is in turn bolted to the bottom 92 of the cylinder base 12 with several bolts. An upper end 94 of the chamber member 80 extends into the chamber bore 40 and has an upper disc 96 that is secured (e.g., press fit, threaded) to the tube portion 78. The tube portion 78 includes an annular groove 98 near an upper end into which an o-ring 100 is seated to seal between the tube portion 78 and the upper disc 96. The upper disc 96, which can be made of AISI 4140 steel, includes an annular recess 102 into which a seal 104 having an E-shaped cross section is seated to seal with and wipe against the interior surface 74 of the chamber bore 40 as the plunger 28 extends and retracts relative to the stationary upper disc 96.

The upper end 16 of the cylinder base 12 also includes a bearing 106 seated on a ledge 108 and configured to slidably engage the exterior surface 32 of the plunger 28. The bearing 106 can be made of C95400 aluminum bronze or any other suitable material. A lower seal 110 having an inverted U-shaped cross section is seated beneath the bearing 106 on a lower ledge 112 that is formed in the interior surface 38 of the plunger bore 30. One arm of the lower seal 110 wipes against the exterior surface 32 of the plunger 28, and the other arm is urged into engagement with the cylinder base 12. An upper seal 114 is seated atop the bearing 106 and is secured in place by an annular retainer 116 that is engaged (e.g., press fit, spring fit) with a notch 118 at the top of the cylinder base 12. Specifically, a lip 120 of the retainer 116 covers a top portion of the upper seal 114 to axially restrain the upper seal 114 relative to the cylinder base 12. The upper seal 114 defines a rim 122 extending radially inward to wipe against the exterior surface 32 of the plunger 28. The lower seal 110 and the upper seal 114 inhibit contaminants from entering the plunger bore 30 and prevent fluid within the plunger bore 30 from leaking, and can be made of polyurethane. The various seals and bearings described are for illustrative purposes and, as one skilled in the art will appreciate, may be modified to accommodate specific application requirements.

With specific reference to FIGS. 2 and 3, the position of the plunger 28 can be adjusted between the retracted state (e.g., shown in FIG. 2) and the extended state (e.g., shown in FIG. 3) by selectively directing a pressurized fluid into one of the extend port 24 (via an extend coupling 24A) and the retract port 26 (via a retract coupling 26A). Directing fluid into an advance chamber 124 urges the plunger 28 toward the extended position. As best shown in FIG. 3, the advance chamber 124 is generally defined and bounded by the plunger bore 30 and the lower end 66 of the plunger 28, including the divider 44 seated near the lower end 66. The tube portion 78 of the chamber member 80 extends through the advance chamber 124 and therefore also defines the volumetric bounds of the example advance chamber 124. Specifically, with reference to FIG. 3, pressurized fluid is directed into the extend port 24 that is in fluid communication with a horizontal extend passageway 126 formed in the lower end 14 of the cylinder base 12. A vertical extend passageway 128 intersects the horizontal extend passageway 126 and is in fluid communication with the advance chamber 124. Under typical circumstances, the inflow of pressurized fluid into the advance chamber 124 will be reduced or stopped manually by an operator prior to the plunger 28 reaching an end of stroke or fully extended position.

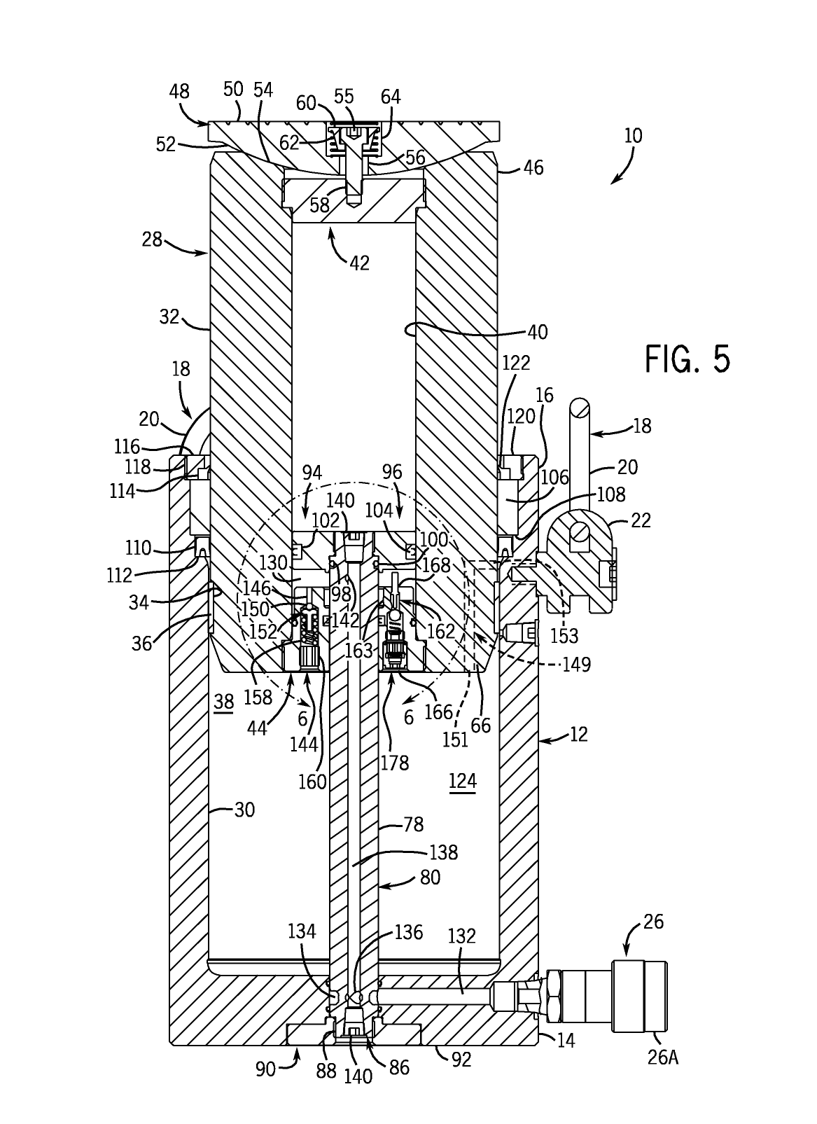

Given that the example cylinder assembly 10 is a double-acting cylinder, the plunger 28 can be forcibly retracted from an extended state to a retracted state via selective introduction of pressurized fluid. Directing fluid into a retract chamber 130 urges the plunger 28 toward the retracted position. As best shown in FIGS. 2 and 5, the retract chamber 130 is generally defined and bounded by the chamber bore 40 (including the divider 44) and the chamber member 80 (including the upper disc 96). To retract the plunger 28, pressurized fluid is directed into the retract port 26 that is in fluid communication with a horizontal retract passageway 132 formed in the lower end 14 of the cylinder base 12. The horizontal retract passageway 132 abuts the lower end 86 of the chamber member 80, which includes an annular recess 134 and a cross passage 136. Fluid flows from the horizontal retract passageway 132, into the annular recess 134, and into the cross passage 136. The cross passage 136 intersects a vertical retract passageway 138 formed along the length of the chamber member 80. The vertical retract passageway 138 of the example chamber member 80 includes plugs 140 at top and bottom ends to define the ends of the vertical retract passageway 138. An upper horizontal retract passageway 142 extends radially outward from the vertical retract passageway 138 to provide fluid communication between the vertical retract passageway 138 and the retract chamber 130.

If the pressure within the retract chamber 130 exceeds a predetermined level (e.g., above approximately three thousand pounds per square inch in the example embodiment), a check valve 144 will open to allow fluid communication between the retract chamber 130 and the advance chamber 124. As best illustrated in FIGS. 5, 6, and 7, the check valve 144 is seated in a check passageway 146 that is formed through the divider 44 of the plunger 28. A valve seat 147 is formed at a conical portion 148 and a ball 150 (made of AISI 1080 steel) is sized to seal with the valve seat 147. The ball 150 is engaged with a ball guide 152 having a notched head 154 and a post 156 extending form the head 154. The ball guide 152 may be formed of AISI 12L14 steel. A spring 158 is fit about the post 156 and is captured between the back side of the head 154 and an insert 160 secured (e.g., threaded) into the check passageway 146. The spring 158 is preferably made of music wire steel and the insert 160 can be made of AISI 12L14 steel. If the pressure within the retract chamber 130 becomes excessive, the ball 150 will be urged against the ball guide 152 to compress the spring 158, ultimately unseating the ball 150 from the valve seat 147 allowing fluid communication between the retract chamber 130 and the advance chamber 124 via the check passageway 146.

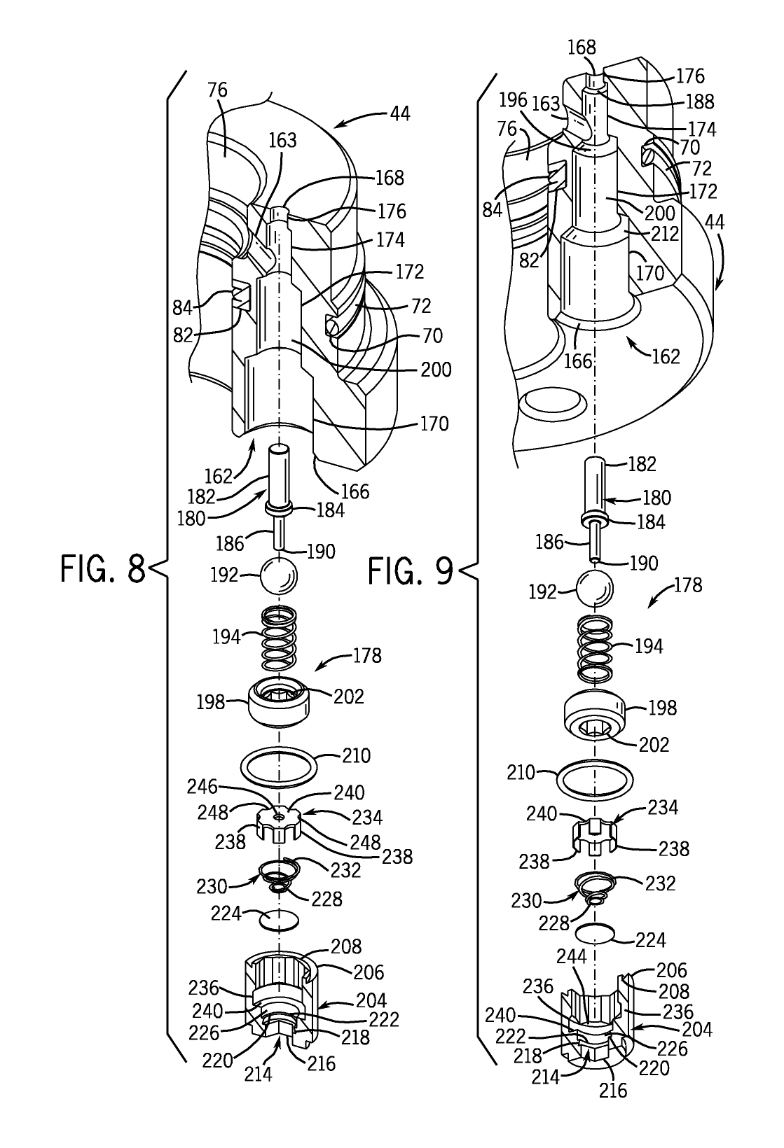

The cylinder assembly 10 also includes automatic stroke shutoff to inhibit the plunger 28 from being urged beyond its predefined end of stroke position, and therefore inhibiting excess stress on the cylinder assembly 10 and associated components. As illustrated in FIGS. 5, 6, 7, 8, and 9, a shunt passageway 162 is formed in and extends through the divider 44 that is coupled to the plunger 28. The shunt passageway 162, when unobstructed, provides fluid communication between the advance chamber 124 and the retract chamber 130. As best shown in FIGS. 8 and 9, the shunt passageway 162 defies a series of aligned, stepped cylindrical portions that taper from a larger opening 166 adjacent the advance chamber 124 to a smaller opening 168 adjacent the retract chamber 130. Specifically, the shunt passageway 162 tapers from a bottom end cylindrical portion 170, to a lower cylindrical portion 172, to an upper cylindrical portion 174, and to a top end cylindrical portion 176. Additionally, the shunt passageway 162 includes a shunt port 163 that is skewed relative to and intersects the upper cylindrical portion 174; the shunt port 163 provides an unimpeded pathway for fluid to flow between the retract chamber 130 and the shunt passageway 162 when a shunt valve assembly 178 is in the opened position.

While the overall dynamic operation of the shunt valve assembly 178 is dependent on a variety of application specific factors (e.g., the present load being supported by the cylinder assembly 10), in one form the shunt valve assembly 178 is configured such that more fluid flows through an open shunt valve assembly 178 (i.e., from the shunt port 163) than is being introduced into the advance chamber 124 (e.g., via a piston pump). This configuration reduces or eliminates excessive stress that can result from overtravel and the accompanying increased pressure within the advance chamber 124. In other applications, for instance, the shunt valve assembly 178 can be configured to flow slightly less fluid than is being introduced and may operate in conjunction with a weep hole (discussed below) to slow the application of excess stress caused by overtravel. In the aspirational configuration, the inflow of fluid is exactly balanced with the outflow of fluid such that the plunger 28 stops extending once the shunt valve assembly 178 has been actuated; this configuration further minimizes the retraction of the plunger 28 once the pressurized fluid is no longer being introduced into the advance chamber 124.

In some situations the shunt valve assembly 178 may cycle or reciprocate between the opened position and the closed position. For instance, if pressurized fluid is continuously introduced into the advance chamber 124 when the shunt valve assembly 178 is in the opened position, the shunt valve assembly 178 will expel sufficient fluid into the retract chamber 130 to allow the plunger 28 to retract far enough to disengage or deactivate the shunt valve assembly 178 (i.e., the shunt valve assembly 178 returns to the closed position). Continuing to supply pressurized fluid into the advance chamber 124 will result in the plunger 28 extending toward a fully extended position, which will again actuate the shunt valve assembly 178 from the closed position to the opened position. This cycle can be repeated until the operator ceases the inflow of fluid (e.g., deactivates a pump). Additionally, the dynamic pulsing introduced into the flow of fluid (e.g., by the repetitive pulsing of a piston pump) can result in cycling of the shunt valve assembly 178, especially when the ball 192 is only slightly unseated from the valve seat 196.

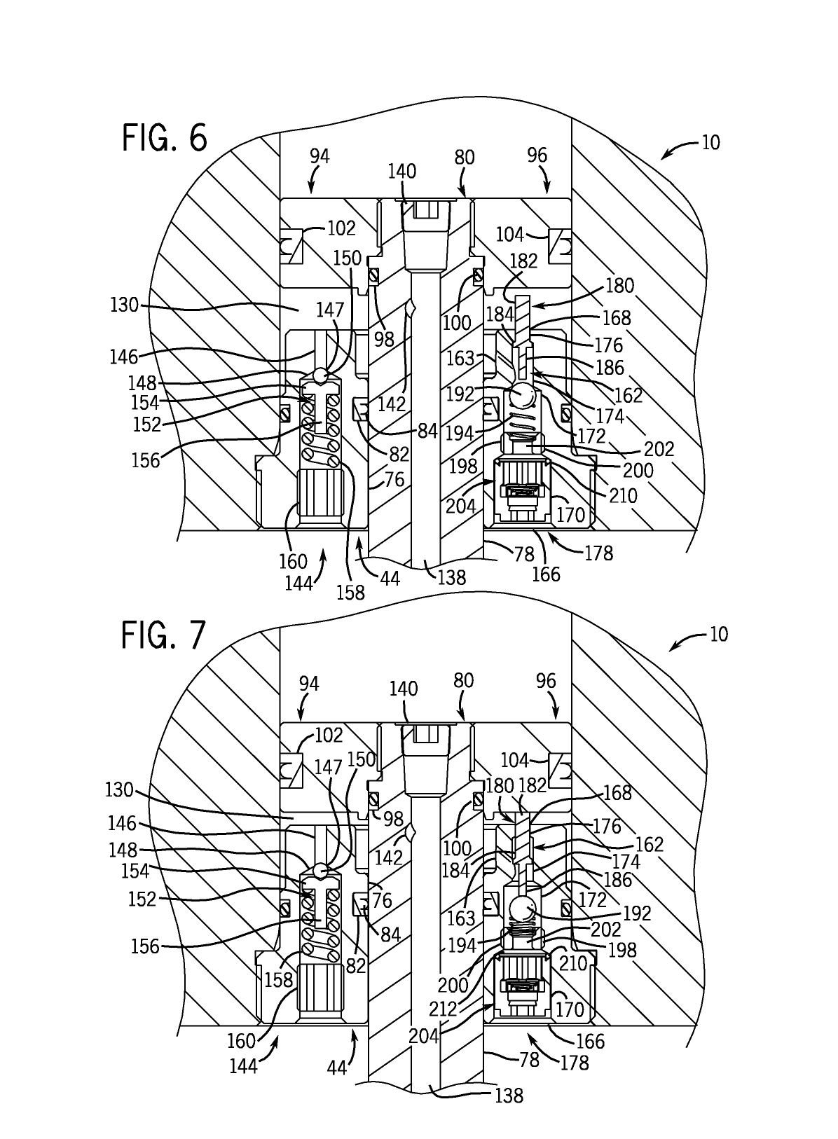

In the example cylinder assembly 10, the shunt valve assembly 178 is seated in the shunt passageway 162. The shunt valve assembly 178 is normally closed and can be selectively opened as the plunger 28 reaches its end of stroke. Specifically, the shunt valve assembly 178 can be moved between a closed position (shown in FIG. 6) at which fluid communication between the advance chamber 124 and the retract chamber 130 is inhibited and an opened position (shown in FIG. 7) at which fluid communication between the advance chamber 124 and the retract chamber 130 is established.

With specific reference to FIGS. 6, 7, 8, and 9, the shunt valve assembly 178 is positioned so that when the plunger 28 is near the extended position (or at the fully extended position or end of stroke) the shunt valve assembly 178 is urged to the opened position. In the opened position, the shunt valve assembly 178 allows pressurized fluid to flow from the advance chamber 124 into the retract chamber 130, thus reducing or eliminating excessive pressure within the advance chamber 124 until the flow of pressurized fluid into the advance chamber 124 is stopped, at which time the shunt valve assembly 178 will close and the plunger 28 is held in the extended position (i.e., absent excessive pressure in the retract chamber 130, a fluid leak, etc.).

The shunt valve assembly 178 includes several components to control the flow of fluid between the advance chamber 124 and the retract chamber 130. An actuator pin 180 includes a larger diameter portion 182 that extends through the top end cylindrical portion 176. A conical flange 184 is formed on the actuator pin 180 between the larger diameter portion 182 and a smaller diameter portion 186. The conical flange 184 is sized to engage a tapered or conical stop surface 188 (shown best in FIG. 9) formed in the shunt passageway 162 between the top end cylindrical portion 176 and the upper cylindrical portion 174 when the shunt valve assembly 178 is in the fully closed position (shown in FIG. 6). The actuator pin 180 may be made of AISI 4340 steel or any other suitable material. An end face 190 of the smaller diameter portion 186 is adjacent to a ball 192, which is urged upward toward the end face 190 by an upper spring 194 that is seated in the lower cylindrical portion 172 with the ball 192. The ball 192 can be made of AISI 1080 steel and the spring 194 can be made from music wire steel. In the closed position, the ball 192 is seated against a conical valve seat 196 (shown best in FIG. 9) formed between the upper cylindrical portion 174 and the lower cylindrical portion 172 to inhibit fluid communication between the advance chamber 124 and the retract chamber 130. The actuator pin 180, the ball 192, and the upper spring 194 are captured in the shunt passageway 162 by an upper cylindrical retainer 198 that is secured (e.g., press fit, threaded) into a lower end 200 of the lower cylindrical portion 172. The retainer 198 defines a central opening 202 to allow fluid to flow through the retainer 198 and can be made from AISI 12L14 steel.

The example shunt valve assembly 178 further includes a lower cylindrical retainer 204 seated in the bottom end cylindrical portion 170. An upper rim 206 of the lower cylindrical retainer 204 defines a generally V-shaped groove 208 into which a seal 210 is seated to abut with and seal against a beveled surface 212 positioned between the bottom end cylindrical portion 170 and the lower cylindrical portion 172. The lower cylindrical retainer 204 includes a contoured interior passage 214 (shown in cross section in FIGS. 8 and 9). A hexagonal opening 216 extends from a bottom of the interior passage 214 toward an inwardly tapering portion 218. A ledge 220 is formed at an upper end of the tapering portion 218 and provides a seat 222 for a disc 224 that is sized to slidably move within a cylindrical portion 226. The disc 224 is engaged by the lower end 228 of a spring 230 and urged toward the seat 222 by the spring 230. Specifically, an upper end 232 of the spring 230 is captured between the disc 224 and an inverted castellated cage 234. The castellated cage 234 is secured in a radially expanded cylindrical portion 236 with ends of legs 238 of the castellated cage 234 engaged with a lower ledge 240. An upper hub 242 of the castellated cage 234 abuts an inwardly beveled surface 244 of the interior passage 214. The legs 238 of the castellated cage 234 extend from the upper hub 242 and are circumferentially spaced. The upper hub 242 includes a central opening 246 and arcuate cutouts 248 to allow and meter the selective flow of fluid along the interior passage 214 when the disc 224 is unseated from the seat 222. In the example embodiment, the lower cylindrical retainer 204, the disc 224, the spring 230, and the castellated cage 234 can be those manufactured by Hawe North America, Inc. of Charlotte, N.C.

During an example operational cycle of the cylinder assembly 10, with the plunger 28 beginning in the retracted position shown in FIG. 2, a pressurized fluid (e.g., hydraulic fluid) is directed into the advance chamber 124 via the extend port 24, the horizontal extend passageway 126, and the vertical extend passageway 128 to ultimately urge the plunger 28 toward the extended position shown in FIGS. 3 and 5. As the plunger 28 approaches the fully extended position or the end of stroke, the shunt valve assembly 178 embedded in the divider 44 of the plunger 28 approaches the upper disc 96 of the chamber member 80. As best shown in FIG. 6, pressurized fluid within the advance chamber 124 unseats the disc 224 from the seat 222 against the urging of the spring 230. The disc 224 is moved upward into the castellated cage 234 such that fluid from the advance chamber 124 flows between the legs 238, through the central opening 246 of the upper hub 242, and past the arcuate cutouts 248. The fluid is inhibited, at this point, from flowing completely through the shunt passageway 162 because the ball 192 remains seated by the upper spring 194 against the valve seat 196.

As shown in FIG. 7, continuing to extend the plunger 28 toward or to the fully extended position results in the larger diameter portion 182 of the actuator pin 180 engaging the upper disc 96 of the chamber member 80, thereby unseating the ball 192 from the valve seat 196 against the urging of the upper spring 194. In other words, the shunt valve assembly 178 is moved or actuated from the closed position to the opened position as a result of the engagement with the chamber member 80, thereby establishing fluid communication between the advance chamber 124 and the retract chamber 130. Fluid in the advance chamber 124 flows through the shunt passageway 162 and along the shunt port 163 into the retract chamber 130. With the shunt valve assembly 178 opened, the fluid enters the retract chamber 130, is directed to the upper horizontal retract passageway 142, into the vertical retract passageway 138, downward to the cross passage 136, outward into the annular recess 134, along the horizontal retract passageway 132, and ultimately to the retract port 26.

The flow of fluid through the opened shunt port 163 can be tailored to various applications by, for instance, altering the size and contours of the shunt port 163. Furthermore, varying the form factor of, for example, the overall shunt passageway 162, the valve seat 196, the ball 192, and/or the upper spring 194 can influence both the dynamic response and the fluid throughput of the shunt valve assembly 178. The dynamic nature of the fluid being introduced into the advance chamber 124 also impacts the dynamics of the shunt valve assembly 178, influencing the ultimate operation (e.g., opening, closing, cycling, etc.) of the shunt valve assembly 178 during use in any particular application.

The example shunt valve assembly 178 configuration reduces the overall stress on the cylinder assembly 10 and associated components (e.g., hoses, pumps, seals, etc.) by reducing or eliminating the pressure spike that typically occurs if a plunger is allowed to overtravel. Given the benefit of this disclosure, one skilled in the art will appreciate the various control options (e.g., valves) that can implement the fluid cylinder assembly concept. For instance, in one form, when the plunger 28 is being extended, the retract chamber 130 must be allowed to drain to accommodate fluid traveling through the shunt port 163 into the retract chamber 130.

With specific reference to FIG. 5, the cylinder assembly 10 may incorporate a weep passageway 149 (shown with dashed lines in FIG. 5) that allows fluid within the advance chamber 124 to flow from the advance chamber 124 if, for instance, the shunt valve assembly 178 malfunctions (e.g., becomes clogged, etc.). The weep passageway 149 is formed in the plunger 28 and extends from a lower opening 151 that is in fluid communication with the advance chamber 124 to an upper opening 153 extending through the exterior surface 32 of the plunger 28. The upper opening 153 is positioned to be slightly below the lower ledge 112 that supports the lower seal 110 when the plunger 28 is near its end of stroke position. In use, if the shunt valve assembly 178 is operational, the stroke of the plunger 28 will be limited prior to the upper opening 153 sliding past the lower seal 110. However, if the shunt valve assembly 178 malfunctions and the plunger 28 moves to a fully extended end of stroke position, the upper opening 153 of the weep passageway 149 will move past the lower seal 110 and thus allow pressurized fluid to flow from the advance chamber 124, into the lower opening 151, through the weep passageway 149, and out through the upper opening 153 to atmosphere, thus reducing the pressure within the advance chamber 124. The location and configuration of the weep passageway 149 can be modified to accommodate any application specific requirements.

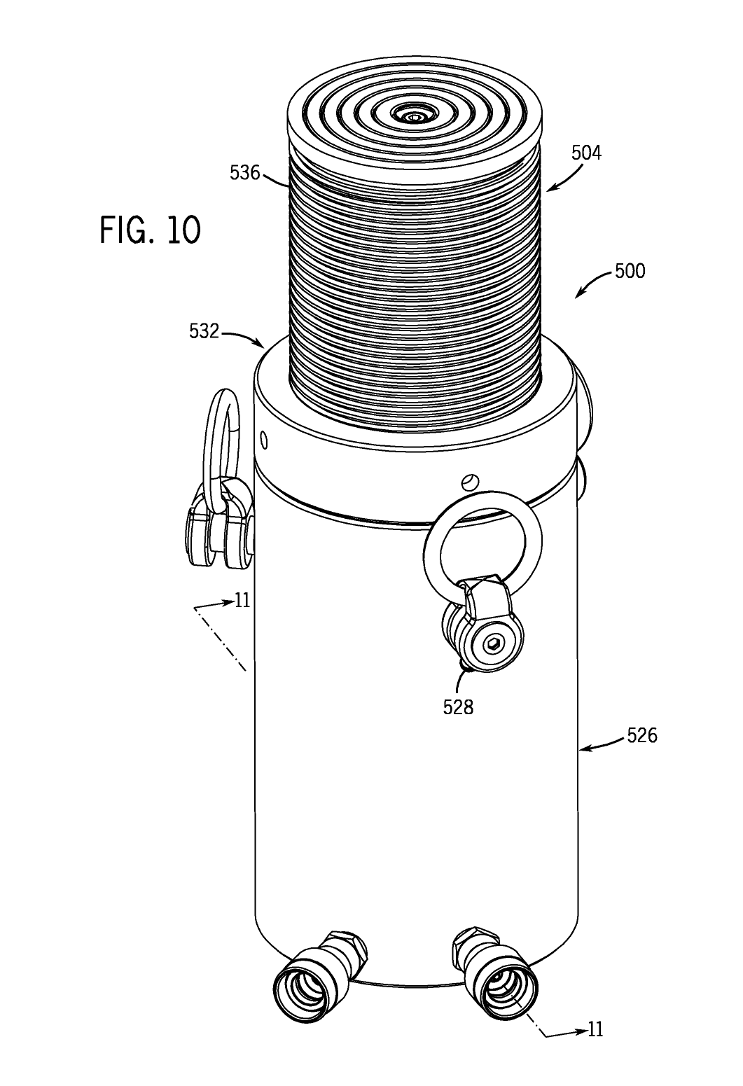

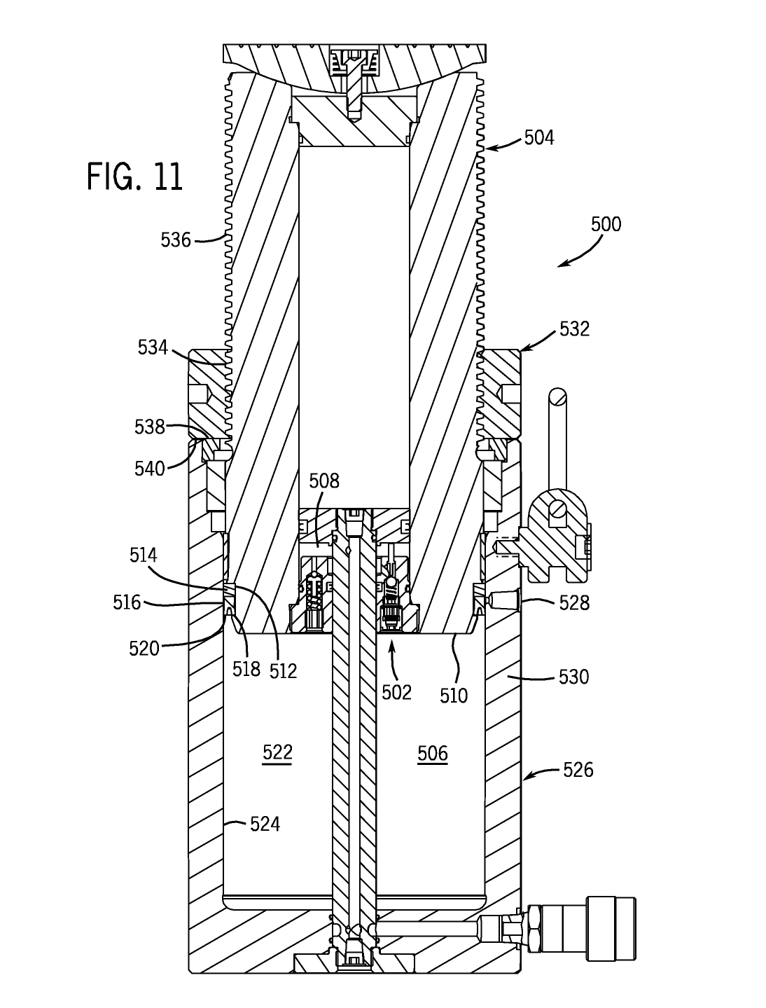

An alternative example fluid cylinder assembly (“cylinder assembly 500”) is shown in FIGS. 10 and 11. Many of the components are similar to those illustrated and described in FIGS. 1-9 and will therefore not be repeated in detail. For instance, the cylinder assembly 500 includes a shunt valve assembly 502 coupled to a plunger 504. As the plunger 504 approaches the extended position, the shunt valve assembly 502 can be engaged to actuate the shunt valve assembly 502 from a closed position (at which fluid is inhibited from flowing between an advance chamber 506 and a retract chamber 508) and an opened position (at which fluid communication between the advance chamber 506 and the retract chamber 508 is established).

Several distinctions from the cylinder assembly 10 are illustrated in FIG. 11. Specifically, a lower end 510 of the plunger 504 includes an annular recess 512 into which a ring 514 is stacked atop an inverted U-shaped annular seal 516. The seal 516 includes a radially inward lip 518 that engages with the annular recess 512 and a radially outward lip 520 that engages with and wipes against an interior surface 522 of a plunger bore 524, which is defined by a cylinder base 526. The cylinder base 526 also includes a weep hole 528 (which is shown plugged in FIG. 5 illustrating the cylinder assembly 10) extending through a vertical wall 530 of the cylinder base 526 that provides further overtravel protection, in addition to the shunt valve assembly 502. Fluid within the advance chamber 506 can escape through the weep hole 528 should the shunt valve assembly 502 malfunction or be unable to accommodate the necessary fluid flow.

Once the plunger 504 has been extended to the desired position, a locknut 532 having internal threads 534 can be engaged with mating external threads 536 formed along the exterior of the plunger 504. The locknut 532 is threaded downward along the plunger 504 to bring a bottom surface 538 of the locknut 532 into engagement with an end face 540 of the cylinder base 526. The locknut 532 can be incorporated as a secondary support to maintain the plunger 504 in the desired position and/or can be configured such that pressurized fluid need not be continually urged into the advance chamber 506 to maintain the position of the plunger 504.

While there has been shown and described what is at present considered the preferred embodiments, it will be appreciated by those skilled in the art, when given the benefit of this disclosure, that various changes and modifications can be made without departing from the scope of the invention defined by the following claims. For instance, while the example shunt valve assemblies are mechanically actuated, the shunt valve assembly can be adapted to be electrically actuated. In one example, the actuator pin 180 can be replaced by an electrical contact. When the electrical contact is actuated (e.g., due to engagement with the chamber member 80), an electrical circuit can be triggered to energize a normally closed solenoid valve, which would allow for fluid communication between the advance chamber 124 and the retract chamber 130. Other various modifications to the broader concept are also within the skill of one of ordinary skill in the art.

I claim:

1. A fluid cylinder assembly comprising:
a cylinder base;
a plunger bore defined by the cylinder base;
a plunger slidably seated within the plunger bore between a retracted position and an extended position;
a chamber bore defined by the plunger;
a chamber member having a first end coupled to the cylinder base and a second end slidably engaged with the chamber bore;
an advance chamber bounded by the plunger bore and the plunger;
a retract chamber bounded by the chamber bore and the chamber member;
a shunt passageway extending between the advance chamber and the retract chamber; and
a valve seated in the shunt passageway and moveable between a closed position at which fluid communication between the advance chamber and the retract chamber is inhibited, and an opened position at which fluid communication between the advance chamber and the retract chamber is established;
wherein the valve is positioned so that when the plunger is near the extended position the valve is in the opened position.

2. The fluid cylinder assembly of claim 1 wherein:
the shunt passageway is formed through the plunger; and
the valve is seated in the plunger.

3. The fluid cylinder assembly of claim 1 wherein a fluid passageway is formed in the chamber member.

4. The fluid cylinder assembly of claim 1 further comprising a divider fixed to the plunger and slidably engaged about the chamber member.

5. The fluid cylinder assembly of claim 4 wherein the shunt passageway is formed through the divider and the valve is seated in the divider.

6. The fluid cylinder assembly of claim 1 wherein the chamber member includes a generally cylindrical pipe extending from the first end to the second end, and a disc coupled to the pipe near the second end.

7. The fluid cylinder assembly of claim 1 wherein the valve is positioned to engage the second end of the chamber member when the plunger is near the extended position to move the valve from the closed position to the opened position.

8. The fluid cylinder assembly of claim 1 wherein the extended position is near an end of stroke of the plunger.

9. The fluid cylinder assembly of claim 1 wherein the valve is embedded in the plunger and configured to engage the chamber member when the plunger is near the extended position.

10. The fluid cylinder assembly of claim 1 further comprising a saddle pivotally coupled to an end of the plunger.

11. The fluid cylinder assembly of claim 1 further comprising:
external threads formed on an exterior surface of the plunger; and
a locknut having internal threads adapted to engage the external threads so that the locknut can be rotated into engagement with an end face of the cylinder base.

12. The fluid cylinder assembly of claim 1 wherein:
a weep passageway is formed in the plunger and extends from a first opening that is in fluid communication with the advance chamber to a second opening extending through an exterior surface of the plunger; and
the weep passageway establishes fluid communication between the advance chamber and atmosphere when the plunger is at an end of stroke position.

13. A fluid cylinder assembly comprising:
a cylinder base;
a plunger bore defined by the cylinder base;
a plunger slidably seated within the plunger bore between a retracted position and an extended position;
a chamber bore defined by the plunger;
a chamber member having a first end coupled to the cylinder base and a second end slidably engaged with the chamber bore;
a divider coupled to the plunger and slidably engaged about the chamber member;
an advance chamber bounded by the plunger bore, the plunger, the chamber member, and the divider;
a retract chamber bounded by the chamber bore, the chamber member, and the divider;
a shunt passageway formed through the divider to provide fluid communication between the advance chamber and the retract chamber; and
a valve seated in the shunt passageway and coupled to the divider, the valve is moveable between a closed position at which fluid communication between the advance chamber and the retract chamber is inhibited, and an opened position at which fluid communication between the advance chamber and the retract chamber is established;
wherein the valve is positioned so that the valve engages the chamber member when the plunger is near the extended position to actuate the valve from the closed position to the opened position to establish fluid communication between the advance chamber and the retract chamber.

14. The fluid cylinder assembly of claim 13 wherein the chamber member includes a generally cylindrical pipe extending from the first end to the second end, and a disc coupled to the pipe near the second end.

15. The fluid cylinder assembly of claim 14 wherein the valve is positioned to engage the disc when the plunger is near the extended position to move the valve from the closed position to the opened position.

16. The fluid cylinder assembly of claim 13 wherein the extended position is near an end of stroke of the plunger.

17. The fluid cylinder assembly of claim 13 further comprising a saddle pivotally coupled to an end of the plunger.

18. The fluid cylinder assembly of claim 13 further comprising:
external threads formed on an exterior surface of the plunger; and
a locknut having internal threads adapted to engage the external threads so that the locknut can be rotated into engagement with an end face of the cylinder base.

19. The fluid cylinder assembly of claim 13 wherein a fluid passageway is formed in the chamber member.

20. The fluid cylinder assembly of claim 13 wherein:
a weep passageway is formed in the plunger and extends from a first opening that is in fluid communication with the advance chamber to a second opening extending through an exterior surface of the plunger; and
the weep passageway establishes fluid communication between the advance chamber and atmosphere when the plunger is at an end of stroke position.
